(19) United States
(12) Patent Application Publication
(10) Pub. No.: US 2011/0305314 A1
(43) Pub. Date: Dec. 15, 2011

(54) ELECTRON EMITTING DEVICE, IMAGE DISPLAY APPARATUS USING THE SAME, RADIATION GENERATION APPARATUS, AND RADIATION IMAGING SYSTEM

(75) Inventors: Shin Kitamura, Machida-shi (JP); Naofumi Aoki, Chigasaki-shi (JP); Yoichi Murakami, Utsunomiya-shi (JP); Kota Aoki, Hiratsuka-shi (JP); Takeo Tsukamoto, Atsugi-shi (JP)

(73) Assignee: CANON KABUSHIKI KAISHA, Tokyo (JP)

(21) Appl. No.: 13/156,166

(22) Filed: Jun. 8, 2011

(30) Foreign Application Priority Data
Jun. 10, 2010 (JP) 2010-133289

(51) Int. Cl. G01N 23/04; H01J 29/10; H01J 9/02

(52) U.S. Cl. 378/62; 313/310; 313/461

(57) ABSTRACT

A field emission type electron emitting device includes a cathode including a mixture of a lanthanum oxide and a molybdenum oxide.

### BACKGROUND OF THE INVENTION

1. Field of the Invention

The present invention relates to an electron emitting device, an image display apparatus such as a television using the same, an X-ray generator, and an X-ray imaging apparatus.

2. Description of the Related Art

In a general field emission type electron emitting device, a voltage is applied between a cathode (also referred to as a cathode electrode or a cathode) and a gate electrode so that an electron is field-emitted from the cathode. Such a field emission type electron emitting device includes a surface-conduction electron emitting device, a metal-insulator-metal (MIM) type electron emitting device, and a ballistic electron surface-emitting device (BSD) type electron emitting device.

A hermetic container (display panel) can be formed by locating a back plate, having a large number of field emission type electron emitting devices arranged in a matrix on its substrate, and a front plate, having a light emitter such as a phosphor arranged thereon, opposite each other and sealing their peripheries. A degree of vacuum in the hermetic container is approximately 10⁻⁶ Pa (Pascal) in practice. An image display apparatus can be configured by connecting a driving circuit to the display panel.

Japanese Patent Application Laid-Open No. 51-25063 and Japanese Patent Application Laid-Open No. 2001-501358 discuss a field emission type electron emitting device in which a surface of a cathode composed of molybdenum (Mo) or the like is coated with a film of an oxide such as a lanthanum oxide.

Japanese Patent Application Laid-Open No. 09-180894 discusses an X-ray generator using a field emission type electron emitting device. Japanese Patent Application Laid-Open No. 2004-228517 discusses an imaging apparatus using a radiant ray such as an X-ray.

When a cathode is composed of a metal such as molybdenum (Mo), a surface of the cathode is changed into an oxide by oxygen included in the atmosphere. As a result, a variation or a decrease in an emission current occurs with time.

On the other hand, La₂O₃ itself has a low work function but has low conductivity so that an electron is not easy to supply. Even if La₂O₃ is directly applied to the surface of the cathode in the field emission type electron emitting device, therefore, the effect of reducing an effective work function is not obtained, and a large emission current cannot be stably taken out.

### SUMMARY OF THE INVENTION

According to an aspect of the present invention, a field emission type electron emitting device includes a cathode including a mixture of a lanthanum oxide and a molybdenum oxide.

According to an exemplary embodiment of the present invention, there can be provided an electron emitting device having a stable electron emission characteristic and a low work function at the same time.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic sectional view illustrating an example of an electron emitting device according to an exemplary embodiment of the present invention.

FIG. 2 is a schematic view illustrating an example of a case where the electron emitting device is driven.

FIG. 3 is a schematic sectional view illustrating an example of an electron emitting device according to another exemplary embodiment of the present invention.

FIGS. 4A to 4C are schematic views illustrating an example of the electron emitting device according to another exemplary embodiment of the present invention.

FIG. 5 is a schematic plan view illustrating an example of an electron source.

FIG. 6 is a schematic sectional view illustrating an example of an image display panel.

FIG. 7 is a block diagram illustrating an example of an information display apparatus including an image display apparatus.

FIGS. 8A to 8F are schematic views illustrating an example of steps of manufacturing an electron emitting device.

FIGS. 9A to 9C are schematic views illustrating an example of an electron emitting device according to another exemplary embodiment of the present invention.

FIGS. 10A to 10G are schematic views illustrating an example of steps of manufacturing an electron emitting device according to another exemplary embodiment of the present invention.

FIGS. 11A to 11C are schematic views illustrating the outline of etching processing of an electron emitting device.

### DESCRIPTION OF THE EMBODIMENTS

Various exemplary embodiments, features, and aspects of the invention will be described in detail below with reference to the drawings.

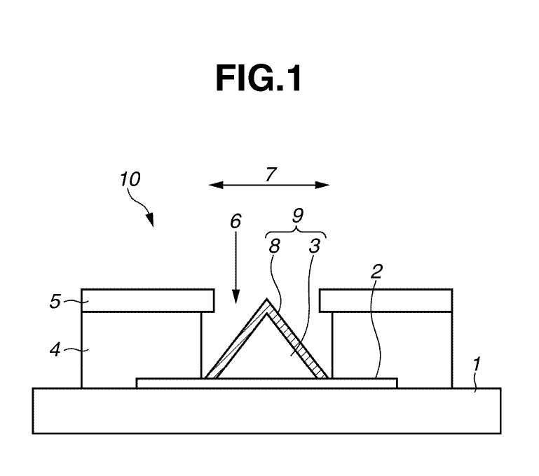

FIG. 1 is a schematic sectional view illustrating an example of an electron emitting device 10 according to an exemplary embodiment of the present invention. A cathode electrode 2 is provided on a substrate 1. The cathode electrode 2 includes a cathode 9 in the shape of a projection. The cathode 9 is of the Spindt type (in a conical shape).

An insulating layer 4 for insulating a gate electrode 5 and the cathode electrode 2 is provided on the cathode electrode 2. An opening 7 for exposing the cathode 9 is provided in the insulating layer 4 and the gate electrode 5 provided on the insulating layer 4, and penetrates the insulating layer 6 and the gate electrode 5. The cathode 9 is arranged in the opening 7.

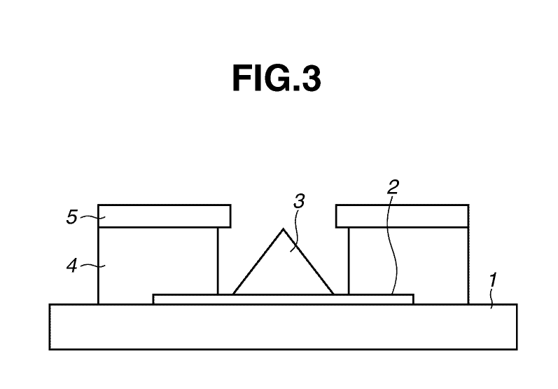

In the present exemplary embodiment, the cathode 9 includes a conductive base 3 and a coating 8. The coating 8 is provided on the base 3 and includes a mixture of a lanthanum oxide and a molybdenum oxide. While the cathode 9 includes the conductive base 3 and the coating 8, an electron emitting portion in the cathode 9 may include a mixture of a lanthanum oxide and a molybdenum oxide. Therefore, the cathode 9 may include only the conductive base 3 without including the coating 8, as illustrated in FIG. 3. In this case, the conductive base 3 includes a mixture of a lanthanum oxide and a molybdenum oxide. More specifically, the cathode 9 including a mixture of a lanthanum oxide and a molybdenum oxide can be used. Further, the cathode electrode 2 and the cathode 9 may be integrally formed. In that case, the cathode electrode 2 also has the same composition as that of the coating 8. However, the coating 8 including a mixture of a lanthanum oxide and a molybdenum oxide in the present exemplary embodiment has a higher resistance than that of a metal film. Therefore, the conductive base 3 composed of a metal such as molybdenum (Mo) may be provided with the coating 8 including a mixture of a lanthanum oxide and a molybdenum oxide.

A material for the conductive base 3 may be Mo from the point of view of a joining characteristic to the coating 8. However, the conductive base 3 can also comprise other metal materials.

While the cathode 9 has a conical shape, the shape of the cathode 9 is not limited to this. However, the cathode 9 may have a projection such as a conical tip.

While the opening 7 may have a circular shape, it may have a polygonal shape. While the cathode electrode 2 and the cathode 9 are separately formed, they may be integrally formed. More specifically, a part of the cathode electrode 2 may be provided with a projection, which can also be the cathode 9.

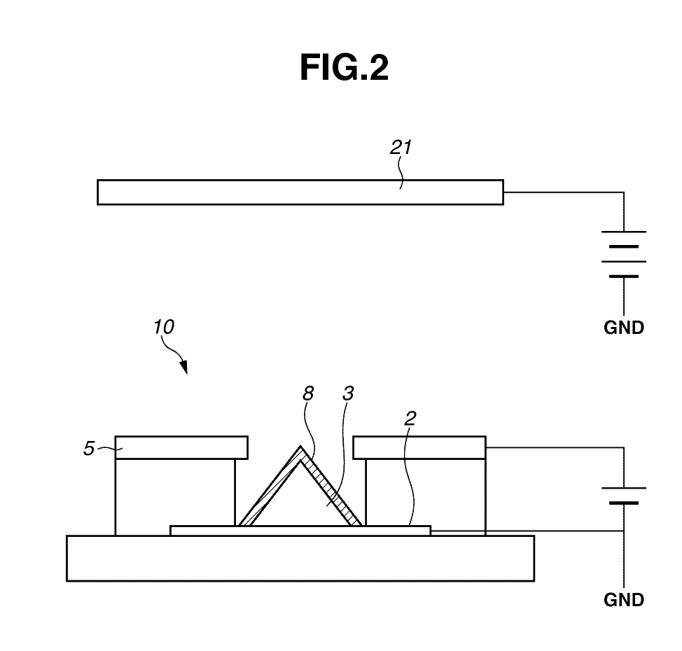

When the electron emitting device 10 in the present exemplary embodiment is driven, the electron emitting device 10 is located opposite an anode electrode 21, as illustrated in FIG. 2. A pressure between the anode electrode 21 and the electron emitting device 10 is kept lower than an atmospheric pressure. A potential at the gate electrode 5 is made higher than that at the cathode electrode 2 while a potential at the anode electrode 21 is made sufficiently higher than that at the gate electrode 5 so that an electron emitted from the cathode 9 (an electron emitted from the coating 8 in this example) is emitted toward the anode electrode 21. At this time, a potential at the cathode 9 is sufficiently lower than that at the anode electrode 21.

The cathode 9 (the coating 8) in the present exemplary embodiment includes a mixture of a lanthanum oxide and a molybdenum oxide. The lanthanum oxide is La₂O₃ in practice. The molybdenum oxide may be a mixture of MoO₂ and MoO₃ in terms of obtaining a good electron emission characteristic. Therefore, the cathode 9 (the coating 8) in the present exemplary embodiment may include a mixture of La₂O₃, MoO₂, and MoO₃. More specifically, if the cathode 9 includes the coating 8 including a mixture of La₂O₃, MoO₂, and MoO₃ in the present exemplary embodiment, an electron is field-emitted from the coating 8. If the cathode 9 includes the conductive base 3 including a mixture of La₂O₃, MoO₂, and MoO₃ without including the coating 8, an electron is field-emitted from the conductive base 3 including a mixture of La₂O₃, MoO₂ and MoO₃.

The field emitting device of the Spindt type has been described as an example of the electron emitting device 10. However, the electron emitting device 10 according to the present exemplary embodiment may also be applied to a surface-conduction type electron emitting device, an MIM type electron emitting device, and a field emitting device using a carbon fiber such as a carbon nanotube.

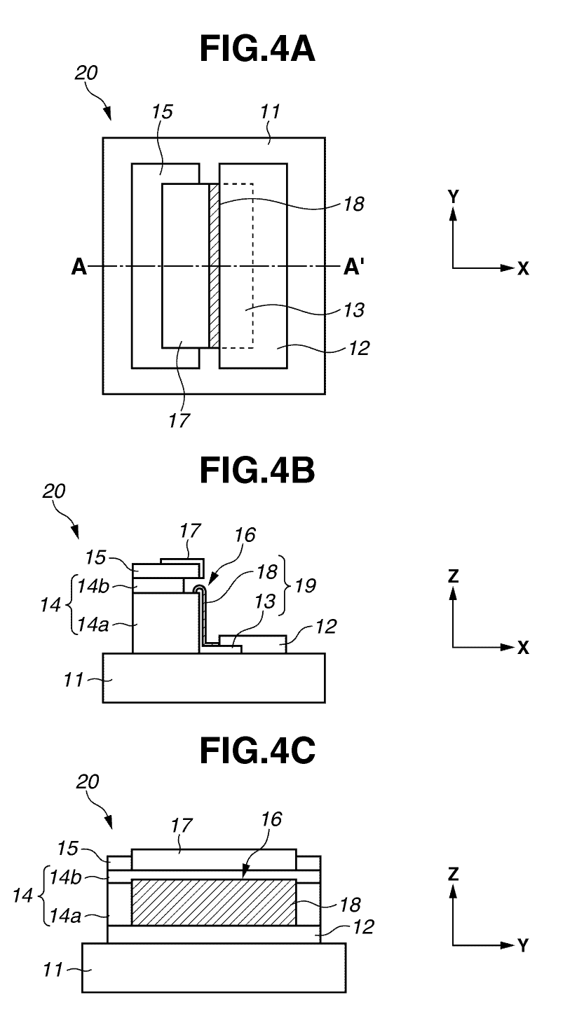

FIGS. 4A, 4B, and 4C schematically illustrate an electron emitting device 20 in a different form from that illustrated in FIG. 1. FIG. 4A is a schematic plan view as viewed in a Z direction, FIG. 4B is a schematic sectional (Z-X plane) view taken along a line A-A′ illustrated in FIG. 4A, and FIG. 4C is a schematic view as viewed in an X direction illustrated in FIG. 4B.

In the electron emitting device 20, an insulating layer 14 is provided on a substrate 11, and a gate electrode 15 is provided on the insulating layer 14. The insulating layer 14 includes a first insulating layer 14a and a second insulating layer 14b in this example. A cathode electrode 12 is provided on the substrate 11, and a conductive base 13 connected to the cathode electrode 12 is provided along and on a side surface of the first insulating layer 14a. The second insulating layer 14b is narrower than the first insulating layer 14a in an X direction. Thus, a recess 16 is formed between the insulating layer 14 (the first insulating layer 14a) and the gate electrode 15. The conductive base 13 can be considered as a conductive film. As apparent from FIG. 4B, the conductive base 13 projects in a Z direction from the substrate 11. More specifically, the conductive base 13 includes a projection. The conductive base 13 has its part entering the recess 16. As a result, the conductive base 13 can include a projection at least a part of which is positioned in the recess 16.

A surface of at least the projection of the conductive base 13 is covered with the coating 18 including a mixture of a lanthanum oxide and a molybdenum oxide, described above. Many parts of the conductive base 13 are covered with the coating 18. A tip of the projection, or a portion, closest to the gate electrode 15, of the projection may be covered with the coating 18. More specifically, the coating 18 may be positioned at least between the conductive base 13 and the gate electrode 15.

In the electron emitting device 20 in the described form, the conductive base 13 and the coating 18 also constitute the cathode 19, like in the above-mentioned form. The cathode electrode 12 has a function of defining a potential at the conductive base 13 and a function of supplying an electron to the conductive base 13. Since the cathode 19 has a shape on which the shape of the projection of the conductive base 13 is reflected, it can include a projection. Therefore, the coating 18 constitutes at least a part of the projection of the cathode 19. More specifically, the coating 18 constitutes at least a part of the surface of the projection of the cathode 19.

While conductive bases 13 and coatings 18 are continuously provided in a Y direction in FIGS. 4A and 4C, they can also be provided at a plurality of positions spaced at intervals of a predetermined distance in the Y direction.

In FIGS. 4A, 4B, and 4C, a part of the gate electrode 15 is covered with a conductive film 17 made of the same material as that for the conductive base 13. The conductive film 17 may be provided to form a stable electric field, although it can be omitted.

In the above-mentioned configuration, the gate electrode 15 and the cathode 19 are arranged with a gap interposed therebetween. A potential higher than a potential at the cathode electrode 12 is applied to the gate electrode 15 so that an electric field is formed in the gap. The electric field enables an electron to be field-emitted from the coating 18 including a mixture of a lanthanum oxide and a molybdenum oxide constituting the cathode 19. In an electron emitting apparatus using the electron emitting device 20 in this form, an anode 21 is also arranged at a position opposite the electron emitting device 20, like in FIG. 2. Therefore, the projection of the cathode 19 and its tip are directed toward the anode 21.

The coating 18 that covers the conductive base 13 may cover a portion, opposite the cathode 19, of at least the gate electrode 15 (the conductive film 17 when the conductive film 17 is provided on the gate electrode 15). In this case, the coating 18 that covers the conductive base 13 and a coating that covers the portion, opposite the cathode 19, of at least the gate electrode 15 are separated from each other (located opposite each other with a gap interposed therebetween). By such a configuration, more electrons, which are field-emitted from the coating 18 including a mixture of a lanthanum oxide and a molybdenum oxide on the side of the cathode 19, are scattered by the coating 18 including a mixture of a lanthanum oxide and a molybdenum oxide provided on the side of the gate electrode 15, so that an amount of electrons that reach the anode 21 is increased. As a result, an electron emission characteristic can be improved.

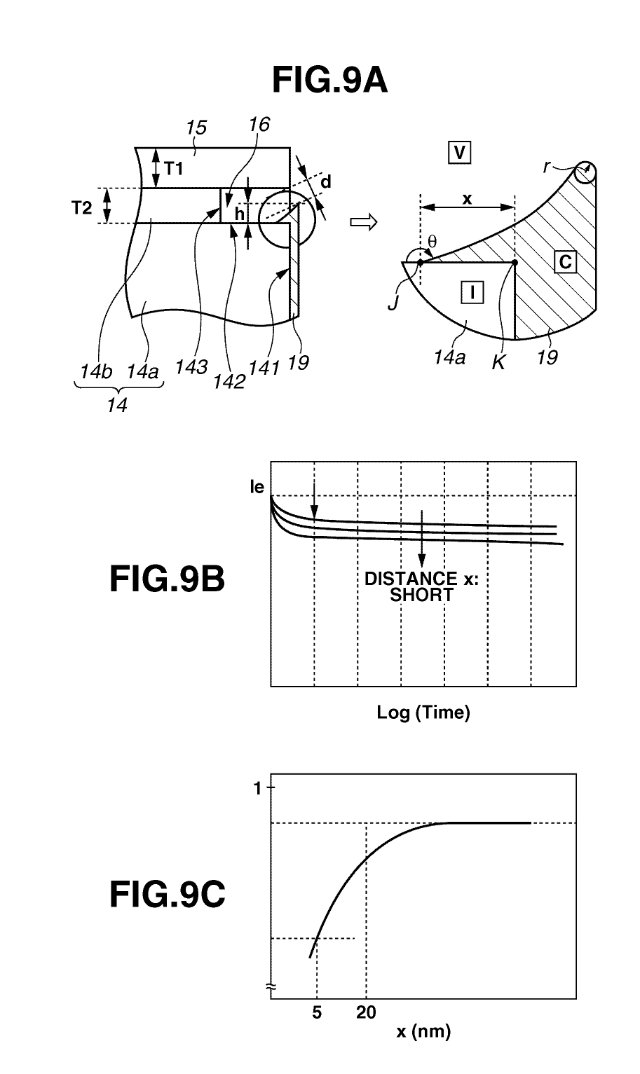

The shape of the cathode 19 will be described below with reference to FIGS. 9A to 9C. FIG. 9A is a schematic sectional view illustrating a projection of the cathode 19 in an enlarged fashion.

The cathode 19 may include the coating 18 in at least a part of the projection, as described above.

FIG. 9A illustrates a form in which a part of the gate electrode 15 is not covered with the conductive film 17 for simplicity of illustration. Even if the conductive film 17 covers the gate electrode 15, however, the conductive film 17 may be considered as a part of the gate electrode 15 because a potential at the conductive film 17 is substantially equal to that at the gate electrode 15. It is much the same for a form in which a portion, opposite the cathode 19, of the gate electrode 15 is covered with the coating 18 including a mixture of a lanthanum oxide and a molybdenum oxide.

A surface of the insulating layer 14 including a first insulating layer 14a and a second insulating layer 14b will be described using separate representations for each portion. More specifically, the surface of the insulating layer 14 can be divided into a side surface 141 of the first insulating layer 14a, an upper surface 142 of the first insulating layer 14a, and a side surface 143 of the second insulating layer 14b. The upper surface 142 of the first insulating layer 14a is a surface, constituting the recess 16, of a surface of the first insulating layer 14a. The side surface 141 of the first insulating layer 14a is a surface, connecting with the upper surface 142 of the first insulating layer 14a, of the surface of the first insulating layer 14a. Thus, the first insulating layer 14a has a step. The projection of the cathode 19 is formed in the vicinity of a bending portion (a point K) serving as a boundary between the upper surface 142 and the side surface 141. The side surface 143 of the second insulating layer 14b constitutes the recess 16. Thus, the recess 16 includes the upper surface 142 and the side surface 143. The upper surface 142 of the first insulating layer 14a and the side surface 143 of the second insulating layer 14b can also be represented as inner surfaces of the insulating layer 14 because they are in the recess 16. On the other hand, the side surface 141 of the first insulating layer 14a can also be represented as an outer surface of the insulating layer 14 because it is outside the recess 16.

Typically, the upper surface 142 of the first insulating layer 14a is substantially parallel to a surface of the substrate 11. On the other hand, in FIG. 4B, the side surface 141 of the first insulating layer 14a is perpendicular to the surface of the substrate 11, and the bending portion is at a right angle thereto. However, the side surface 141 of the first insulating layer 14a may be inclined to the surface of the substrate 11. More specifically, the side surface 141 may be an inclined plane. Particularly, the side surface 141 may be inclined at an acute angle to the surface of the substrate 11. When the side surface 141 is an inclined plane, an angle of a corner of the first insulating layer 14a (an angle on the side of the insulating layer 14) can be an obtuse angle. The side surface 141 actually has a certain degree of curvature, although it makes aright angle or an obtuse angle to the surface of the substrate 11.

The gate electrode 15 is spaced a distance T2 away from the upper surface 142 of the first insulating layer 14a. The distance T2 corresponds to a thickness of the second insulating layer 14b. More specifically, the second insulating layer 14b is a layer used for defining a distance between the upper surface 142 of the first insulating layer 14a and the gate electrode 15.

In the present exemplary embodiment, the projection of the cathode 19 may be positioned over the upper surface 142 of the first insulating layer 14a and the side surface 141 of the first insulating layer 14a. More specifically, the projection of the cathode 19 may contact the upper surface 142 of the first insulating layer 14a by its part being positioned in the recess 16. Thus, an interface is formed between the projection of the cathode 19 and the upper surface 142 of the first insulating layer 14a.

In FIG. 9A, a distance h (h>0) indicates that the projection of the cathode 19 projects by a height h from the upper surface 142 of the first insulating layer 14a. A portion spaced the height h away from the upper surface 142 is a tip of the projection. A distance x (x>0) is a width, in a depth direction of the recess 16, of the interface between the projection of the cathode 19 and the upper surface 142 of the first insulating layer 14a. In other words, the distance x is a distance from an end (point J) of the projection, which contacts the surface of the insulating layer 14 constituting the recess 16 to an edge of the recess 16, i.e., the bending portion (point K) of the first insulating layer 14a. The distance x is in a range from 10 nm to 100 nm in practice depending on the depth of the recess 16.

With such a configuration, a contact area between the projection of the cathode 19 and the first insulating layer 14a is widened, and a mechanical contact force between the projection of the cathode 19 and the first insulating layer 14a is improved. Thus, stripping of the cathode 19, for example, can be suppressed even via a manufacturing process of the electron emitting device.

With such a configuration, a variation in emission current can be suppressed. This point will be described in detail.

FIG. 9B illustrates an amount of time variation of Ie when the distance x in the recess 16 is changed, where Ie is an amount of emitted electrons, i.e., an amount of electrons that reach the anode 21. An average amount of emitted electrons Ie detected in the first 10 seconds after driving of the electron emitting device 20 was started was obtained as an initial value. Standardization was performed using the initial value as a basis, and a change of the amount of emitted electrons Ie was plotted as a common logarithm of time. As understood from FIG. 9B, an amount of decrease from the initial value of the amount of emitted electrons Ie tends to increase as the distance x decreases.

FIG. 9C illustrates a result of similar measurement in some devices to that illustrated in FIG. 9B. In FIG. 9C, standardization was performed using the initial value of the amount of emitted electrons Ie as a basis for the distance x, and the amount of emitted electrons Ie obtained after the lapse of a predetermined period of time since driving of the electron emitting device 20 was started was plotted. As apparent from FIG. 9C, the shorter the distance x is, the larger an amount of decrease from the initial value is. When the distance x exceeds 20 nm, dependency on the distance x tends to decrease. Thus, the distance x may be 20 nm or more.

It is presumed from these results that when the distance x increases, a contact area between the projection and the first insulating layer 14a is widened so that a heat resistance can be reduced, and a heat capacity is increased by an increase in the volume of the projection of the cathode 19. More specifically, a rise in temperature of the cathode 19 is reduced so that an initial variation is reduced.

On the other hand, when the distance x is extremely increased, a leak current between the cathode 19 and the gate electrode 15 is increased via an inner surface of the recess 16, i.e., the upper surface 142 of the first insulating layer 14a and the side surface 143 of the second insulating layer 14b. At least, the distance x may be smaller than the depth of the recess 16.

An angle θ between a surface of the cathode 19) of the cathode 19 positioned on the upper surface 142 of the first insulating layer 14a (particularly, a surface in the vicinity of the end (point J) of the cathode 19) and the upper surface 142 of the first insulating layer 14a may be larger than 90°. The angle θ may be smaller than 80°. The angle θ is an angle on the vacuum side in the angle between the surface of the cathode 19 and the upper surface 142 of the first insulating layer 14a. If the upper surface 142 is considered to be a plane, a contact angle between the cathode 19 and the upper surface 142 is represented by “180°-θ”. The upper surface 142 of the first insulating layer 14a is considered to be a plane in practice. In other words, the contact angle between the upper surface 142 and the cathode 19 may be larger than 0° and smaller than 90°.

Further, the surface of the cathode 19 may be gently inclined to the upper surface 142 of the first insulating layer 14a in the recess 16. More specifically, an angle between a tangent to a surface of any portion, positioned in the recess 16, of the cathode 19 and the upper surface 142 of the first insulating layer 14a may be smaller than 90°.

Thus, abnormal discharge generated in the recess 16 can be suppressed. This point will be described in detail.

Generally, a place where three types of materials, which differ in dielectric constants, such as a vacuum, an insulator, and a conductor, simultaneously contact one another is referred to as a triple junction. An electric field at the triple junction may be extremely higher than that in its periphery, which constitutes a factor for discharge or the like depending on a condition. In the present exemplary embodiment, the point J illustrated in FIG. 9A is also a triple junction of a vacuum (V), an insulator (I), and a conductor (C). If an angle e at which the projection of the cathode 19 and the first insulating layer 14a contact each other is 90° or more, the electric field at the triple junction does not greatly differ from that in its periphery. The projection of the cathode 19 is at the angle to the first insulating layer 14a so that an electric field strength at the triple junction occurring at the insulator-vacuum-conductor is weakened, which enables prevention of a discharge phenomenon occurring by generation of an abnormal electric field.

FIG. 9A illustrates a distance d between the gate electrode 15 and the tip of the projection of the cathode 19. The distance d is the shortest distance between the gate electrode 15 and the cathode 19. A shape in the vicinity of the tip of the projection illustrated in FIG. 9A can be represented by a radius of curvature r.

When a potential difference between the gate electrode 15 and the cathode 19 is constant, the strength of an electric field formed in the vicinity of the tip of the projection differs depending on the radius of curvature r and the distance d. The smaller the radius of curvature r is, the stronger the electric field to be formed in the vicinity of the tip can be. The smaller the distance d is, the stronger the electric field to be formed in the vicinity of the tip can be.

When the electric field in the vicinity of the tip of the projection is constant, the radius of curvature r can be made relatively large if the distance d is relatively small. On the other hand, the distance d can be made relatively large if the radius of curvature r is relatively small. A difference in the distance d affects a difference in the number of times of scattering of the emitted electrons. The smaller the radius of curvature r is and the larger the distance d is, the higher the efficiency of the electron emitting device 20 can be. An efficiency (η) is given by η=Ie/(If+Ie) using a current (If) detected when a voltage is applied to the electron emitting device 20 and a current (Ie) taken out in a vacuum.

An example of a method for manufacturing the electron emitting device 20 illustrated in FIGS. 4A to 4C will be described below. The substrate 11 includes quartz glass, glass having a decreased content of impurities such as Na, soda lime glass, and a silicon substrate. The substrate 11 may use a material not only having a high mechanical strength but also having a high resistance to alkalis and acids such as dry etching, wet etching, and a developer as its feature, a material that slightly differs in coefficient of thermal expansion from a deposition material or another laminate member when used as a single body such as a display panel, and a material into which an alkali element from the inside of the glass is not easily diffused as heat treatment is performed.

First, the first insulating layer 14a and the second insulating layer 14b are sequentially formed to form a step on the substrate 11. The gate electrode 15 is laminated on the second insulating layer 14b.

The first insulating layer 14a is a film having an insulating property composed of a material superior in processability, for example, a silicon nitride film or a silicon oxide film, and is formed by methods such as general vacuum deposition such as sputtering, chemical vapor deposition (CVD), and vacuum evaporation. The thickness of the first insulating layer 14a is set in a range from several nanometers (nm) to several ten micrometers (μm), such as in a range from several ten nanometers to several hundred nanometers.

The second insulating layer 14b is an insulating film composed of a material superior in processability, for example, a silicon nitride film or a silicon oxide film, and is formed by methods such as general vacuum deposition, for example, CVD, vacuum evaporation, or sputtering. The thickness T2 of the second insulating layer 14b is set in a range from several nanometers to several hundred nanometers, such as in a range from several nanometers to several ten nanometers.

In order to form the recess 16 with high accuracy, the first insulating layer 14a and the second insulating layer 14b may be composed of different materials, as described in detail below. The first insulating layer 14a can be composed of a silicon nitride, and the second insulating layer 14b can be composed of a silicon oxide, or phosphor-silicate glass (PSG) having a high phosphorous concentration or boron-silicate glass (BSG) having a high boron concentration.

The gate electrode 15 has conductivity, and can be formed by a general vacuum deposition technique such as evaporation or sputtering. The thickness T1 of the gate electrode 15 is set in a range from several nanometers to several hundred nanometers, such as in a range from several ten nanometers to several hundred nanometers.

A material for the gate electrode 15 maybe a material having a higher coefficient of thermal conductivity in addition to conductivity, and having a high melting point. Examples include metals such as beryllium (Be), magnesium (Mg), titanium (Ti), zirconium (Zr), hafnium (Hf), vanadium (V), niobium (Nb), tantalum (Ta), molybdenum (Mo), tungsten (W), aluminum (Al), copper (Cu), nickel (Ni), chromium (Cr), gold (Au), platinum (Pt), and palladium (Pd) or alloy materials, and include compounds such as a nitride, an oxide, and a carbide, a semiconductor, carbon (C), and a carbon compound.

The first insulating layer 14a, the second insulating layer 14b, and the gate electrode 15 can be patterned using a photolithographic technique and etching processing. The etching processing includes reactive ion etching (RIE).

The second insulating layer 14b is then selectively etched, to form the recess 16 in the insulating layer 14 including the first insulating layer 14a and the second insulating layer 14b. The ratio of etching amounts of the first insulating layer 14a and the second insulating layer 14b may be 10 or more, such as 50 or more.

The selective etching can use a mixed solution of an ammonium fluoride and a hydrofluoric acid, which is referred to as a buffered hydrogen fluoride (BHF) if the second insulating layer 14b is a silicon oxide, and can use a hot phosphoric acid-based etchant if the second insulating layer 14b is a silicon nitride, for example.

The depth of the recess 16 (the width of the exposed upper surface 142 of the first insulating layer 14a) is greatly associated with a leak current after device formation. The deeper the recess 16 is, the smaller a value of the leak current becomes. If the recess 16 is too deep, however, the gate electrode 15 may be deformed. Therefore, the depth of the recess 16 may be approximately 30 nm to 200 nm.

The recess 16 can also be formed by masking a part of a side surface of an insulating layer to remove a part of the insulating layer without performing selective etching depending on a material. In the case, the first insulating layer 14a and the second insulating layer 14b need not be formed of separate materials, and may be formed as a single insulating layer. The insulating layer may be a trilaminar insulating layer including three layers, and the second layer may be subjected to selective etching. In the case, the recess 16 is formed of a surface of the trilaminar insulating layer.

A material for the conductive base 13 is then made to adhere to the upper surface 142 and the side surface 141 of the first insulating layer 14a. The material for the conductive base 13 may be a material having a high coefficient of thermal conductivity in addition to conductivity and having a high melting point. The material for the conductive base 13 may be a material having a work function of 5 eV or less. Examples include metals such as Be, Mg, Ti, Zr, Hf, V, Nb, Ta, Mo, W, Al, Cu, Ni, Cr, Au, Pt, and Pd or alloy materials. Particularly, Mo can be used.

The conductive base 13 can be formed by a general vacuum deposition technique such as evaporation or sputtering. The conductive base 13 can be formed by controlling an incident angle and a deposition time of a conductive material, a temperature during formation, and a degree of vacuum during formation to control the shape of the projection of the cathode 19 in the present exemplary embodiment, as described above. The incident angle of the conductive material can be determined in consideration of the thickness T1 of the gate electrode 15, the thickness T2 of the second insulating layer 14b, and so on. FIG. 9A can be referred to for T1 and T2.

The coating 18 in the present exemplary embodiment is then formed on the surface of the conductive base 13. The coating 18 can be formed by sputtering, for example. More specifically, the coating 18 can be formed by co-sputtering using a lanthanum (La) target and a Molybdenum (Mo) target.

The cathode electrode 12 can be formed using a general vacuum deposition technique such as evaporation or sputtering. Alternatively, the cathode electrode 12 can also be formed by burning a precursor including a conductive material. A pattern forming method includes a photolithographic technique and a printing technique.

A material for the cathode electrode 12 may have conductivity, and includes a similar material to that for the gate electrode 15. The thickness of the cathode electrode 12 is set in a range from several ten nanometers to several micrometers, such as in a range from several ten nanometers to several hundred nanometers. The cathode electrode 12 may be provided before the conductive base 13 is formed, or may be provided after the conductive base 13 or the coating 18 is formed.

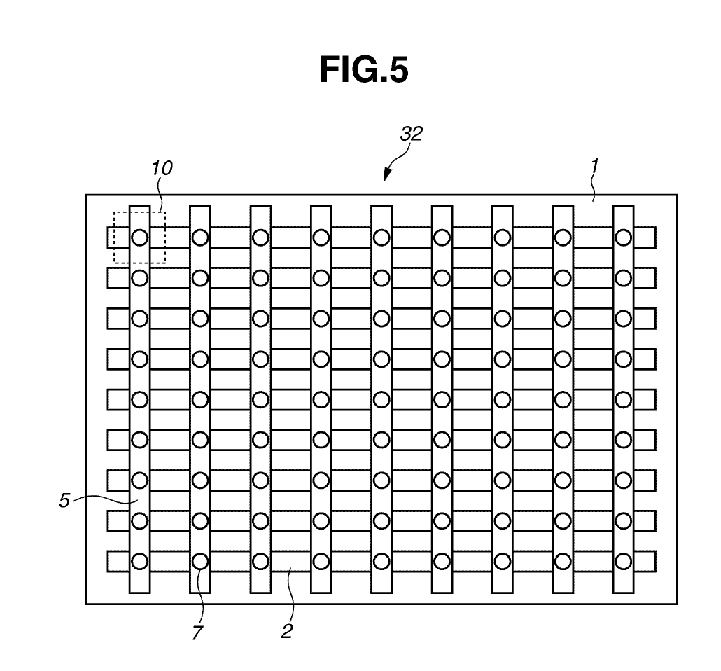

An example of an electron source 32 in which a large number of electron emitting devices 10 in the form described with reference to FIG. 1 are arranged on a substrate 1 will be described below with reference to FIG. 5. FIG. 5 is a schematic plan view of the electron source 32.

The electron source 32 includes the substrate 1 and a plurality of electron emitting devices 10 provided on the substrate 1. The substrate 1 includes an insulating substrate, and may be a glass substrate, for example. A large number of electron emitting devices 10 described with reference to FIG. 1, for example, are arranged in a matrix on the substrate 1. A gate electrode 5 is common to and connected to the electron emitting devices 10 in the same column, and a cathode electrode 2 is common to and connected to the electron emitting devices 10 in the same row. The electron emitting device 10 can also be replaced with the electron emitting device 20 described with reference to FIGS. 4A to 4C.

Electrons can be emitted from a predetermined number of electron emitting devices 10 by selecting, out of a plurality of cathode electrodes 2, the predetermined number of cathode electrodes 2, selecting, out of the plurality of gate electrodes 5, the predetermined number of gate electrodes 5, and applying a voltage between the selected electrodes.

While the number of electron emitting devices 10 provided at an intersection between one of the cathode electrodes 2 and one of the gate electrodes 5 is one, a plurality of electron emitting devices 10 may be provided. For example, a plurality of openings 7 is provided at each of the intersections between the cathode electrodes 2 and the gate electrodes 5, and a cathode 9 is provided in each of the openings 7.

FIG. 5 illustrates an example in which one opening 7 is provided at each of the intersections between the cathode electrodes 2 and the gate electrodes 5 in a simplified fashion. However, the number of cathodes 9 provided at each of the intersections may be larger from the point of view of reducing a fluctuation of an emission current. When the number of cathodes 9 is large, the fluctuation of the emission current is averaged. On the other hand, too many cathodes 9 may undesirably be provided at each of the intersections from the point of view of productivity. The fluctuation of the emission current can be reduced by using the coating in the present exemplary embodiment. Even if the number of cathodes 9 is not increased, therefore, the fluctuation of the emission current can be reduced.

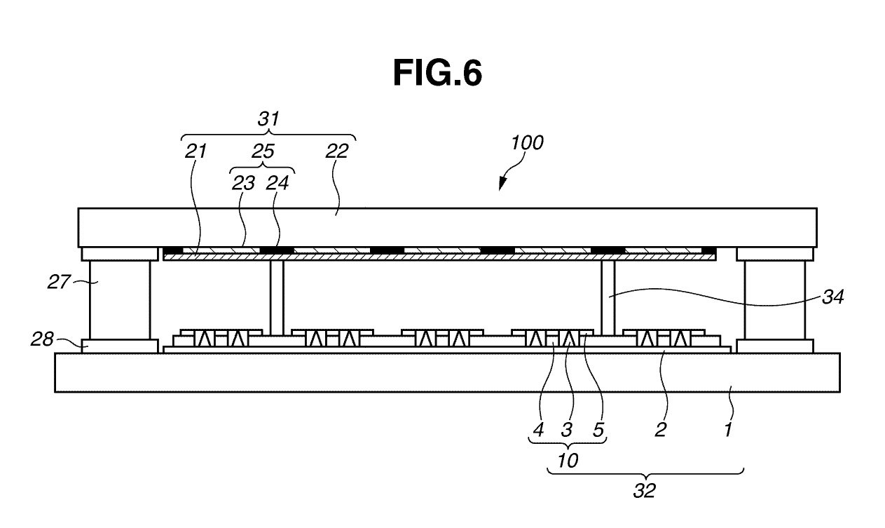

An example in which an image display panel 100 is configured using the above-mentioned electron source 32 will be described with reference to FIG. 6. In this example, a plurality of cathodes 9 is provided at each of intersections.

The image display panel 100 is hermetically held so that a pressure inside thereof becomes lower than an atmospheric pressure (vacuum). Therefore, the image display panel 100 can be restated as a hermetic container.

FIG. 6 is a schematic sectional view of the image display panel 100. The image display panel 100 uses the electron source 32 illustrated in FIG. 5 as a back plate, and the back plate 32 and a front plate 31 are located opposite each other.

A closed-circular (rectangular) support frame 27 is provided between the back plate 32 and the front plate 31 so that the back plate 32 and the front plate 31 are spaced by a predetermined distance away from each other. A joining member 28 having a sealing function such as indium or frit glass forms airtight joints, respectively, between the support frame 27 and the front plate 31 and between the support frame 27 and the back plate 32. The support frame 27 also has a function of hermetically sealing an inner space of the image display panel 100. When the area of the image display panel 100 is large, a plurality of spaces 34 may be arranged between the front plate 31 and the back plate 32 inside the image display panel 100 so that a distance between the front plate 31 and the back plate 32 can be maintained.

The front plate 31 includes a light emission layer 25 including a light emitter 23, which emits light when irradiated with an electron emitted from an electron emitting device 10, an anode electrode 21 provided on the light emission layer 25, and a transparent substrate 22.

The transparent substrate 22 includes a glass substrate, for example, because it transmits light emitted from the light emission layer 25.

The light emitter 23 generally includes a phosphor. The light emission layer 25 includes a light emitter for emitting red light, a light emitter for emitting green light, and a light emitter for emitting blue light, to constitute a full-color image display panel 100. In a form illustrated in FIG. 6, the light emission layer 25 includes a black member 24 provided between light emitters 23. The black member 24 is a member, which is generally referred to as a black matrix, for improving contrast of a display image.

The electron emitting device 10 for irradiating each of the light emitters 23 with an electron is located opposite the light emitter 23. More specifically, each of the electron emitting devices 10 corresponds to one light emitter 23.

The anode electrode 21 is generally referred to as a metal back, and can typically be composed of an aluminum film. The anode electrode 21 can also be provided between the light emission layer 25 and the transparent substrate 22. In the case, the anode electrode 21 is composed of an optically transparent conductive film such as an indium tin oxide (ITO) film.

A process for hermetically joining the front plate 31 and the back plate 32 (a joining process) may be performed under a situation where members constituting the image display panel 100 serving as a hermetic container are heated.

In the joining process, the support frame 27 having a joining member such as frit glass provided therein is typically arranged between the front plate 31 and the back plate 32. The front plate 31, the back plate 32, and the support frame 27 are heated in a range from 100° C. to 400° C., for example, while being pressurized, and are then cooled to room temperature. Prior to the joining process, the back plate 32 may be subjected to degassing processing by heating. The coating described in the present exemplary embodiment is not stripped from the conductive base 3 even via such a process accompanied by heating and cooling.

Even when the image display panel 100 is similarly manufactured using the electron emitting device 20, the coating 18 is not stripped and the conductive base 13 is not stripped even via the process accompanied by heating and cooling.

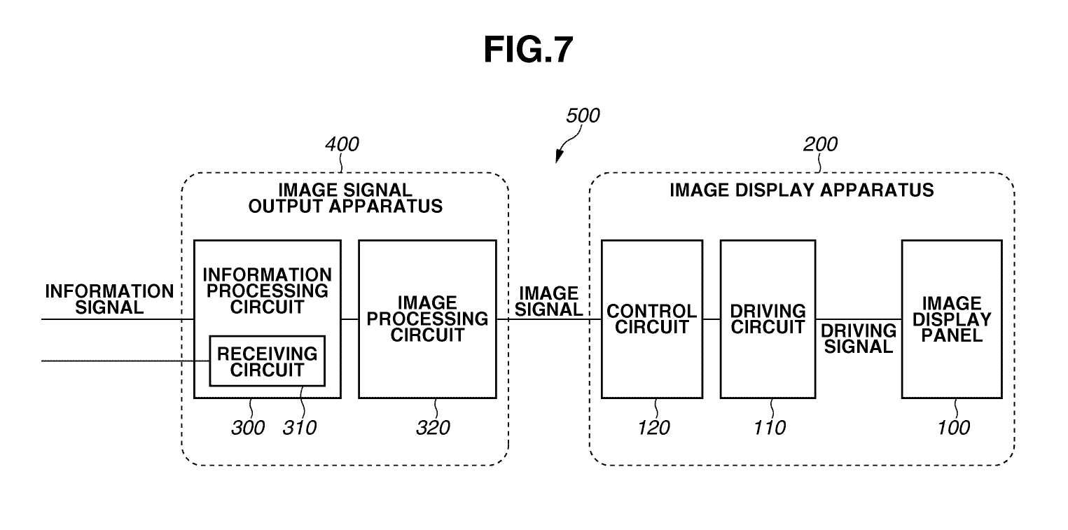

As illustrated in FIG. 7, an image display apparatus 200 can be configured by connecting a driving circuit 110 for driving the image display panel 100 to the above-mentioned image display panel 100, as illustrated in FIG. 7. Further, an information display apparatus 500 can be configured by further connecting an image signal output apparatus 400 for outputting an information signal such as a television broadcast signal or a signal recorded in an information recording apparatus as an image signal.

The image display apparatus 200 includes at least the image display panel 100 and the driving circuit 110, and may include a control circuit 120. The control circuit 120 subjects an input image signal to signal processing such as correction processing suitable for the image display panel 100 while outputting an image signal and various control signals to the driving circuit 110. The driving circuit 110 outputs a driving signal to each of wirings in the image display panel 100 (see the cathode electrode 2 and the gate electrode 5 illustrated in FIG. 1) in response to the input image signal. The driving circuit 110 includes a modulation circuit for converting the image signal into a driving signal, and a scanning circuit for selecting the wiring. A voltage applied to the electron emitting device corresponding to each of pixels in the image display panel 100 is controlled in response to the driving signal output from the driving circuit 110. Thus, each of the pixels emits light at a luminance corresponding to the image signal so that an image is displayed on a screen. “Screen” can correspond to the light emission layer 25 in the image display panel 100 illustrated in FIG. 6.

According to the present exemplary embodiment, a coating having a low work function is used for the electron emitting device so that an applied voltage for electron emission (for driving of the electron emitting device) can be reduced. Therefore, power consumption of the image display apparatus 200 can be reduced. A stable emission current is obtained so that the quality of a displayed image can be improved.

FIG. 7 is a block diagram illustrating an example of the information display apparatus 500. The information display apparatus 500 includes an image signal output apparatus 400 and an image display apparatus 200. The image signal output apparatus 400 includes an information processing circuit 300, and may further include an image processing circuit 320. The image signal output apparatus 400 may be contained in a different casing from that for the image display apparatus 200. At least a part of the image signal output apparatus 400 may be contained in the same casing as that for the image display apparatus 200. A configuration of the information display apparatus 500 is an example, and can be subjected to various modifications.

An information signal such as a television broadcast signal for satellite broadcasting or terrestrial broadcasting or a data broadcast signal via an electrical communication line such as the Internet connected by a wireless network, a telephone network, a digital network, an analog network, and a transmission control protocol/internet protocol (TCP/IP) is input to the information processing circuit 300. Storage devices such as a semiconductor memory, an optical disk, and a magnetic storage device are connected to the information processing circuit 300 so that the information signals recorded therein can also be displayed on the image display panel 100. Video input apparatuses such as a video camera, a still camera, and a scanner are connected to the information processing circuit 300 so that images obtained therefrom can also be displayed on the image display panel 100. The information processing circuit 300 can also be connected to a system such as a video conference system or a computer.

Further, an image to be displayed on the image display panel 100 can also be processed, be output by a printer, or be recorded in the storage device.

Information included in the information signal includes at least one of video information, character information, and voice information. The information processing circuit 300 can be provided with a receiving circuit 310 including a tuner for selecting information from a broadcast signal and a decoder for decoding, when the information signal is encoded, the encoded information signal.

An image signal obtained by the information processing circuit 300 is output to the image processing circuit 320. The image processing circuit 320 can include a circuit for subjecting the image signal to various types of processing. Examples of the image processing circuit 320 include a gamma correction circuit, a resolution conversion circuit, and an interface circuit. An image signal, which has been converted into a signal format of the image display apparatus 200, is output to the image display apparatus 200.

A method for outputting the video information or the character information to the image display panel 100 and displaying the video information or the character information on a screen can be performed in the following manner, for example. First, an image signal corresponding to each of pixels in the image display panel 100 is generated from the video information or the character information in the information signal input to the information processing circuit 300. The generated image signal is input to the control circuit 120 in the image display apparatus 200. A voltage to be applied to each of the electron emitting devices in the image display panel 100 from the driving circuit 110 is controlled, to display an image in response to the image signal input to the driving circuit 110. An audio signal is output to an audio reproduction unit (not illustrated) such as a speaker separately provided, and is reproduced in synchronization with the video information or the character information displayed on the image display panel 100.

A radiation generation apparatus for generating an X-ray (a radiant ray) using the electron emitting device according to the present exemplary embodiment will be described below. The whole radiation generation apparatus is sealed into a vacuum chamber made of glass. The electron emitting device in the present exemplary embodiment is arranged on one side of the chamber, and a radiation exit surface (an anode) serving as a target is installed opposite thereto on the other side thereof. The arrangement of the electrodes is similar to that of a radiation generation apparatus using a normal thermal electron source.

A basic configuration of the vacuum chamber can use a similar configuration to that of a chamber of the image display panel 100 illustrated in FIG. 6. More specifically, a radiation generation apparatus can be basically formed if the light emission layer 25 illustrated in FIG. 6 is excluded from the image display panel 100. In the radiation generation apparatus, a material for the anode 21 serving as the radiation exit surface can use a thin plate composed of a tungsten (W), copper (Cu), chromium (Cr), iron (Fe), and cobalt (Co), depending on a direction in which a radiant ray is taken out. The material is selected depending on energy (a wavelength) of a radiant ray. The anode 21 may include a cooling mechanism for cooling the anode 21. As a cooling structure, a piping 24 for circulating water is provided in the anode 21, for example. The vacuum chamber may be provided with a window for guiding a radiant ray generated from the anode 21 into a sample. This window is covered with a thin film composed of beryllium (Be) or aluminum (Al). A high voltage of several ten kilovolts to several hundred kilovolts is applied between the electron emitting device and the anode 21 so that a potential on the side of the electron emitting device becomes lower to accelerate an electron beam.

A compact radiation imaging system can be formed by arranging a well-known area sensor (a radiation imaging apparatus) having a large number of photoelectric conversion elements for receiving a radiant ray and converting the received radiant ray into an electrical signal arranged on its substrate in a matrix to be located opposite the radiation generation apparatus. At this time, the radiant ray received by the radiation imaging apparatus is a radiant ray, which has been generated from the radiation generation apparatus and has been transmitted by an object to be detected positioned between the radiation generation apparatus and the radiation imaging apparatus.

Aspects of the present invention will be described in more detail below with examples.

### EXAMPLE 1

An electron emitting device 10 including a coating 8 on a conductive base 3 in a conical shape illustrated in FIG. 1 was prepared, and was driven, as illustrated in FIG. 2, to make electron emission measurement. 100 electron emitting devices were formed on the substrate 1.

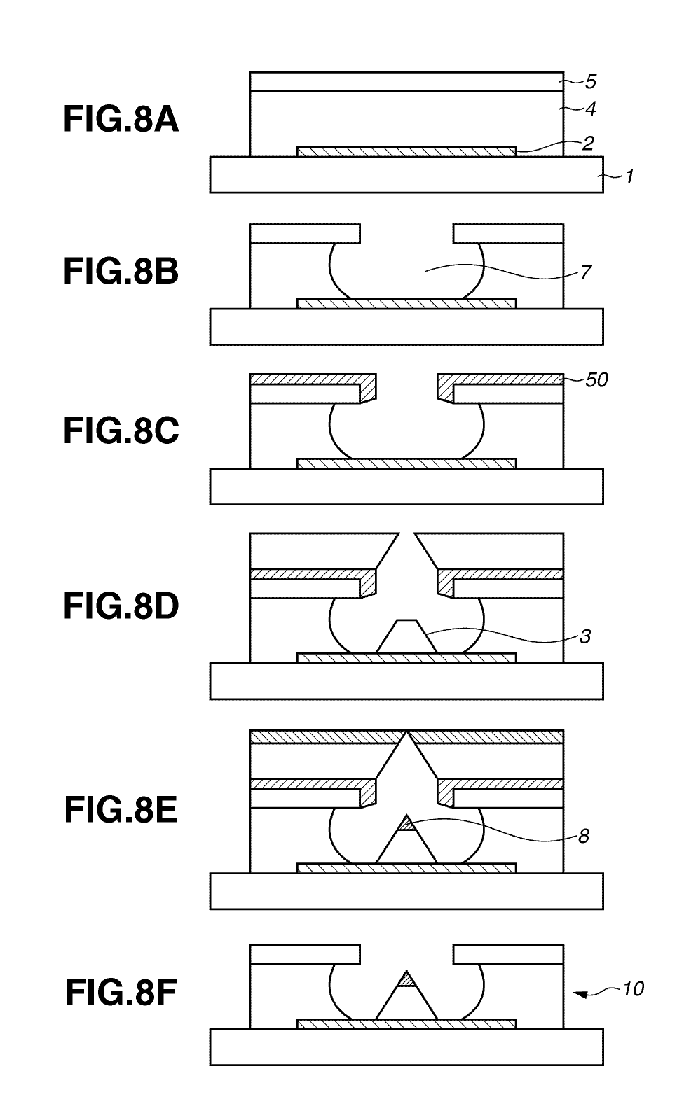

A method for manufacturing the electron emitting device 10 in the example 1 will be described below with reference to FIGS. 8A to 8F. A coating 8 serving as a film including a mixture of a lanthanum oxide and a molybdenum oxide was provided on only a projection (a tip) of the conductive base 3 in a substantially conical shape.

(Step 1) A Cr layer was formed on the substrate 1 made of glass by sputtering and then patterned, to form a cathode electrode 2 on the substrate 1. Then, an SiO₂ layer 4 was formed as an insulating layer on the cathode electrode 2 by CVD, and a Cr layer 5 serving as a gate electrode was then further formed on the insulating layer 4 by sputtering (FIG. 8A).

(Step 2) A circular opening 7 was formed by photolithography and wet etching on the Cr layer 5 serving as a gate electrode, and the SiO₂ layer 4 was wet-etched using the Cr layer 5 as a mask, to form a gate hole (opening) 7 (FIG. 8B). 100 (10 in width×10 in length) openings 7 were formed in a lattice shape. The SiO₂ layer 4 was wet-etched until the cathode electrode 2 was exposed.

(Step 3) An Al layer 50 serving as a stripping layer was formed on the Cr layer 5 by rotational oblique evaporation (FIG. 8C).

(Step 4) Mo was deposited on the substrate 1 by sputtering in a direction perpendicular to the substrate 1. Thus, a conductive base 3 in a substantially conical shape composed of Mo was obtained on the cathode electrode 2 (FIG. 8D).

(Step 5) Co-sputtering was performed with a Mo target and a La target directed into the gate hole 7. Thus, a coating 8 including a mixture of a lanthanum oxide and a molybdenum oxide was formed at a tip (a projection) of the conductive base 3 in a substantially conical shape composed of Mo (FIG. 8E). The co-sputtering (dual-target sputtering) was performed while guiding oxygen into an atmosphere. A distance between the target and the substrate 1 was 180 mm, and Ar pressure during sputtering was 1.7 Pa. A power supply and power to the La target were 0.10 kW in a direct current (DC), and a power supply and power to the Mo target were 0.33 kW in the DC.

(Step 6) The Al layer 50 serving as a stripping layer was then selectively wet-etched, to remove Mo on the Al layer 50 and a film including a mixture of a lanthanum oxide and a molybdenum oxide on the Al layer 50.

(Step 7) Annealing processing was finally performed at a temperature of 450° C. in a vacuum. In the foregoing steps, the electron emitting device 10 was formed (FIG. 8F).

A voltage was applied, as illustrated in FIG. 2, between the cathode electrode 2 and the gate electrode 5 in the electron emitting device 10 thus formed so that 100 devices could be operated.

When a portion corresponding to the coating 8 in the formed electron emitting device 10 was measured using electron energy loss spectroscopy (EELS), the existence of MoO₂, MoO₃, and La₂O₃ was confirmed

The electron emitting device 10, together with an anode 21, was held in a vacuum chamber (not illustrated), and was connected to a power supply for applying a voltage between the cathode electrode 2 and the gate electrode 5 via a current guiding terminal and a power supply for applying a voltage to the anode 21. A shunt resistor (not illustrated) is inserted between the anode 21 and the power supply for applying the voltage to the anode 21, a voltage difference at both ends of the shunt resistor was measured so that a current flowing as a result of electron emission can be measured. The inside of the vacuum chamber is kept at a pressure of 1×10⁻⁶ Pa or less by being evacuated using an ion pump. The anode 21 is spaced a distance of 3 mm away from the electron emitting device 10.

A power supply for applying a voltage between the cathode electrode 2 and the gate electrode 5 can apply a pulse-shaped voltage (a rectangular wave voltage). More specifically, a pulse voltage having a rectangular waveform having a pulse width of 6 milliseconds and having a period of 24 milliseconds was applied, to form an electric field for electron emission. The pulse voltage having the rectangular waveform was applied between the cathode electrode 2 and the gate electrode 5 while a voltage of 1 kV was applied to the anode 21. A sequence for measuring an average of currents emitted depending on the pulse voltage having the rectangular waveform continuously applied 32 times was executed at intervals of two seconds, and a deviation and a mean value per 15 minutes were found, to calculate a fluctuation of an electron emission current. At this time, a peak-to-peak value of the rectangular wave voltage was previously adjusted between the cathode electrode 2 and the gate electrode 5 so that an average of the currents would be 10 μA.

When an electron emission characteristic of the electron emitting device 10 in the example 1 was thus measured, it was superior in stability. Electron emission was confirmed from a low voltage, and a large emission current could be obtained. A work function was 3.5 eV or less when calculated from the electron emission characteristic and a shape of a tip of a cathode 9.

### COMPARATIVE EXAMPLE 1

As a comparative example 1, Mo was sputtered until an opening of an Al layer 50 serving as a sacrifice layer in step 4 to form a Mo cathode 9 in a conical shape without performing step 5 in the example 1, to produce an electron emitting device. When an electron emission characteristic of the electron emitting device was measured in a similar manner to that in the example 1, the electron emitting device more widely fluctuated in an emission current and was poorer in stability of the electron emission characteristic than the electron emitting device 10 in the example 1. The electron emitting device was higher in a voltage at which electron emission was started and had a higher work function than the electron emitting device 10 in the example 1.

### COMPARATIVE EXAMPLE 2

As a comparative example 2, sputtering was performed using only a La target in step 5 in the example 1 to form a coating 8 composed of La₂O₃, to produce an electron emitting device. When an electron emission characteristic of the electron emitting device was measured in a similar manner to that in the example 1, an emission current was configured immediately after the measurement was started. However, the emission current could hardly be observed immediately.

### COMPARATIVE EXAMPLE 3

As a comparative example 3, sputtering was performed using only a Mo target in step 5 in the example 1, to form a coating 8 mainly composed of MnO₃ without performing step 7 in the example 1, to produce en electron emitting device. When an electron emission characteristic of the electron emitting device was measured in a similar manner to that in the example 1, an emission current could be less observed than that in the electron emitting device in the comparative example 2.

### COMPARATIVE EXAMPLE 4

As a comparative example 4, sputtering was performed using only a Mo target in step 5 in the example 1, to form a coating 8 mainly composed of MoO₂, to produce an electron emitting device. When an electron emission characteristic of the electron emitting device was measured in a similar manner to that in the example 1, the electron emitting device was superior in stability of the electron emission characteristic to the electron emitting devices in the comparative examples 1 and 2. However, the electron emitting device was higher in a voltage at which field emission was started and had a higher work function than the electron emitting device 10 in the example 1. The electron emitting device was lower in a maximum value of an emission current under the same driving voltage than the electron emitting device 10 in the example 1.

### EXAMPLE 2

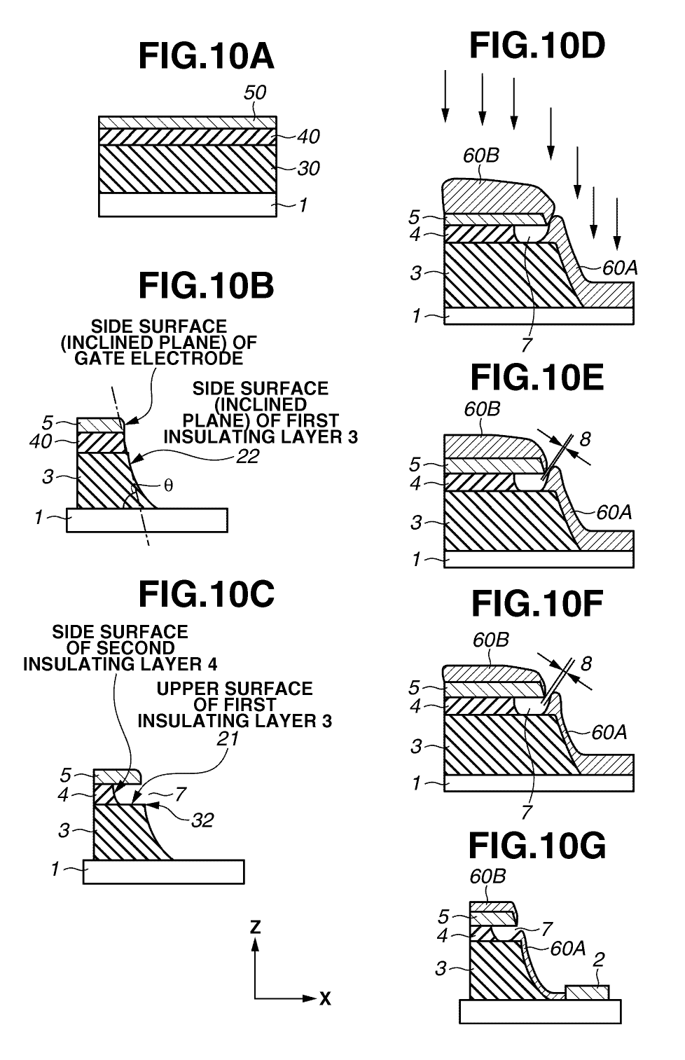

A method for manufacturing an electron emitting device in this example 2 will be described with reference to FIGS. 10A to 10G. A substrate 1 uses high strain point low-sodium glass (PD200 manufactured by Asahi Glass Company).

(Step 1) Insulating layers 30 and 40 and a conductive layer 50 were first laminated on the substrate 1, as illustrated in FIG. 10A. The insulating layer 30 was a silicon nitride (Si₃N₄) film having an insulating property composed of a material superior in processability, and was found using sputtering, and the thickness thereof was 500 nm. The insulating layer 40 was a silicon oxide (SiO₂) film having an insulating property composed of a material superior in processability, and was formed using sputtering, and the thickness thereof was 30 nm. The conductive film 50 was a tantalum nitride (TaN) film, and was formed using sputtering, and the thickness thereof was 30 nm.

(Step 2) A resist pattern was then formed on the conductive layer 50 by a photolithographic technique, and the conductive layer 50, the insulating layer 40, and the insulating layer 30 were processed in this order using dry etching, as illustrated in FIG. 10B. By this first etching processing, the conductive layer 50 was changed into a gate electrode 5 by being patterned, and the insulating layer 30 was changed into a first insulating layer 3 by being patterned.

As processing gas at this time, CF4-based gas was used for the insulating layers 30 and 40 and the conductive layer 50. As a result of performing RIE using the gas, an angle of a side surface after etching of the insulating layer 30, the insulating layer 40, or the gate electrode 5 was an angle of approximately 80° to a surface (a horizontal plane) of the substrate 1.

(Step 3) After a resist was stripped, the insulating layer 40 was etched so that the depth of a recess 7 would be approximately 100 nm using BHF (high-purity buffered hydrogen fluoride LAL100 manufactured by STELLA CHEMIFA CORPORATION), as illustrated in FIG. 10C. By this second etching processing, the recess 7 was formed in a step formation member including first and second insulating layers 3 and 4. In this step, an upper surface of the first insulating layer 3 was exposed while a side surface of the second insulating layer 4 retreated.

(Step 4) A film composed of Mo was then made to adhere to an inclined plane and an upper surface (an inner surface of the recess 7) of the first insulating layer 3 and the gate electrode 5, to simultaneously deposit a conductive film 60A and a conductive film 60B, as illustrated in FIG. 10D. At this time, the conductive film 60A and the conductive film 60B contacted each other, as illustrated in FIG. 10D.

In this example, directional sputtering was used as a deposition method. The substrate 1 was set so that an angle of its surface was horizontal to a sputter target (Mo target). A shielding plate was provided between the substrate 1 and the Mo target so that sputter particles were incident on a surface of the substrate 1 at a limited angle (specifically, an angle of 90±10° to the surface of the substrate 1). Further, argon plasma was generated at a power of 3 kW and a degree of vacuum of 0.1 Pa, and the substrate 1 was installed so that a distance between the substrate 1 and the Mo target would be 60 mm or less (an average free stroke at a degree of vacuum of 0.1 Pa). The conductive film 60A was formed at an evaporation speed of 10 nm/min so that the thickness of Mo on the inclined plane of the insulating layer 3 was made to be 60 nm.

At this time, a conductive film 60A was formed so that an amount in which the conductive film 60A enters the recess (the distance x in FIG. 9) was made to be 35 nm.

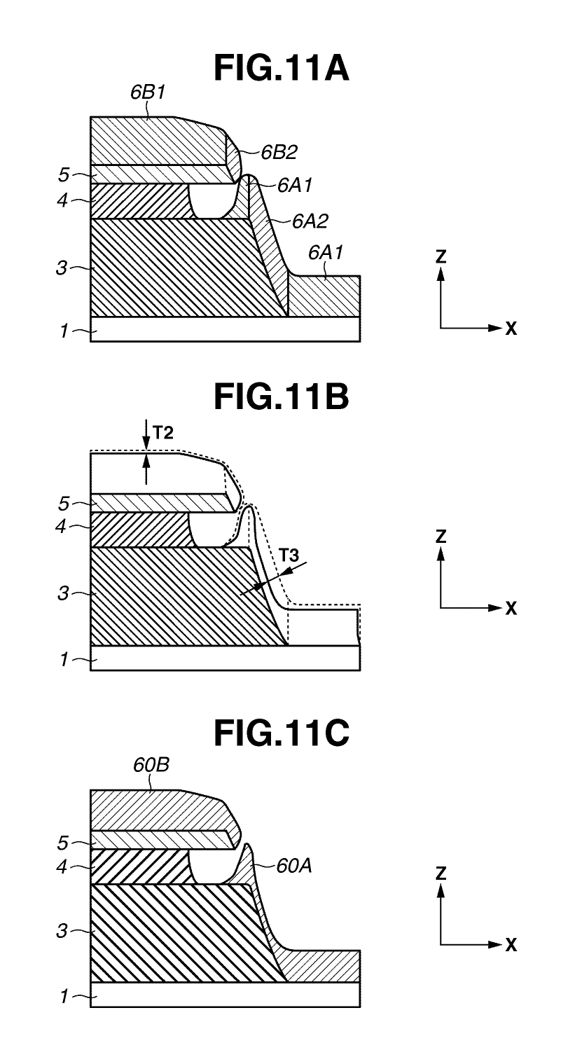

Transmission electron microscope (TEM) observation and electron energy loss spectroscopy (EELS) analysis were performed for a sample prepared in similar processes to the above processes. When the film density of Mo was calculated based on the results, a portion having a high film density (corresponding to portions 6A1 and 6B1 illustrated in FIG. 11A, described below) was 10.0 g/cm³, and a portion having a low film density (corresponding to portions 6A2 and 6B2 illustrated in FIG. 11A, described below) was 7.8 g/cm³.

(Step 5) In order to form a gap 8, etching processing (third etching processing) was then performed for the conductive film 60A and the conductive film 60B, as illustrated in FIGS. 10E and 10F.

The third etching processing was performed by etching processing in a first stage and etching processing in a second stage, specifically described below.

The etching processing in the first stage includes a process of oxidizing surfaces of the conductive films 60A and 60B composed of Mo and a process of removing the oxidized surfaces.

More specifically, as a method for oxidizing Mo, excimer ultraviolet rays (UV) (wavelength: 172 nm, and illuminance: 18 mw/cm²) exposure apparatus was used, to irradiate excimer UV at 350 mJ/cm² under atmospheric pressure. Under this condition, an oxidation layer was formed on the respective surfaces of the conductive film 60A and the conductive film 60B in a film thickness of approximately 3 nm on an inclined plane having a low film density and in a film thickness of approximately 1 to 2 nm in a portion having a high film density. The oxidation layer was then dipped in hot water (45° C.) for five minutes, to remove a molybdenum oxide layer. In this process, the gap 8 was formed between the conductive film 60A and the conductive film 60B (FIG. 10E).

Then, as the etching processing in the second stage, a tip of a projection of the conductive film 60A was sharpened, as illustrated in FIG. 10F. The etching processing in the second stage was performed to widen the gap 8 formed by the etching processing in the first stage simultaneously with the sharpening. In the etching processing in the second stage, a molybdenum oxide film was formed in an oxidation process, and the oxide film was removed in a removal process, to etch the conductive film 60A, like in the etching processing in the first stage.

This time, three cycles each including a process of oxidation by excimer UV (irradiation at 350 mJ/cm²) and oxide film removal by hot water (45° C., dipping for five minutes) were performed.

As a result of analysis by section TEM, the shortest distance 8 between the projection of the conductive film 60A and the gate electrode 5 was 15 nm on average, as illustrated in FIG. 10F. In the foregoing processes, the conductive film 60A serving as the conductive base 3, described above, was formed.

The formation of the gap and the sharpening processing of the tip (projection) of the conductive film 60A using the third etching processing will be described with reference to FIGS. 11A, 11B, and 11C.

FIG. 11A illustrates a state where the conductive films (60A and 60B) were deposited by a deposition method having directivity in step 4. By sputtering having directivity, sputter particles collide at an angle close to 90° with each of a surface of the gate electrode 5, a surface of the substrate 1, and the top of a corner of the first insulating layer 3, and an upper surface of the first insulating layer 3 (an angle between a direction in which the sputter particles fly and the surface). The sputter particles means particles sputtered from a sputter target. Therefore, a high-quality film (represented by a “high-density film” or “a film having a high film density”) is formed in the above-mentioned portion.

On the other hand, the sputter particles collide at a shallow angle with each of an inclined plane of the first insulating layer 3 and a surface in the vicinity of an end of the gate electrode 5. Therefore, a low-density film (or “a film having a low film density”) is formed on the surface.

In FIG. 11A, schematically illustrated portions 6A1 and 6B1 of the conductive films 60A and 60B and schematically illustrated portions 6A2 and 6B2 thereof respectively represent a high-density film and a low-density film.

As described above, the film density and the etching rate are inverse proportional to each other. Therefore, in the third etching processing, the schematically illustrated portions 6A2 and 6B2 of the conductive films 60A and 60B are higher in etching rate than the schematically illustrated portions 6A1 and 6B1 thereof. In step 5, all the exposed surfaces of the conductive films are exposed to an etchant (are etched).

FIGS. 11B and 11C respectively illustrate states where the third etching processing has been performed. In the present exemplary embodiment, a relationship of “T2<T3” holds, where T2 is an amount of decrease in film thickness by the third etching processing in a high-density film portion, and T3 indicates an amount of decrease in film thickness by the third etching processing in a low-density film portion. The amount of decrease in film thickness by the third etching processing can be adjusted by an etching time or the number of times of etching. Since the relationship of “T2<T3” holds, sharpening of the end (projection) of the conductive film 60A is promoted by repeatedly performing the etching processing (FIG. 11C).

If a material for the conductive films (60A and 60B) is Mo, the high-density film may have a film density of 9.5 g/cm³ or more and 10.2 g/cm³ or less, and the low-density film may have a film density of 7.5 g/cm³ or more and 8.0 g/cm³ or less. The above-mentioned values are in a practical range considering the resistivity and the film thickness of the film (the low-density film is formed on an inclined plane, and thus the low-density film portion also decreases in film thickness) and an etching rate difference.

X-ray reflectometry (XRR) is generally used to measure the film density. However, an actual electron emitting device may be difficult to measure. In such a case, the following method can be used, for example, as a method for measuring the film density. More specifically, the film density can be calculated by performing quantitative analysis of an element using a high-resolution electron energy-loss spectroscopy microscope that is a combination of TEM and EELS, and comparing the element with a film having the existing film density to generate an analytical curve.

(Step 6) As illustrated in FIG. 10G, an electrode 2 was then formed. Cu was used for the electrode 2. The electrode 2 was generated using sputtering, and the thickness thereof was 500 nm.

(Step 7) From a similar angle to that in the process described with reference to FIG. 10D, dual-target sputtering was performed under a similar condition to that in the example 1 using a La target and a Mo target. As a result, a coating (not illustrated) including a mixture of a lanthanum oxide and a molybdenum oxide was formed in a thickness of 30 nm on surfaces of the conductive films 60A and 60B composed of Mo. In this step, a part or the whole of the gap described with reference to FIG. 10F was filled with the coating. More specifically, the conductive films 60A and 60B were connected to each other by the coating.

(Step 8) A voltage was repeatedly applied between the cathode electrode 2 and the gate electrode 5 in a vacuum so that a potential at the gate electrode 5 was higher than a potential at the cathode electrode 2 using a pulse power supply (not illustrated). Thus, a gap was formed in the coating including a mixture of a lanthanum oxide and a molybdenum oxide between the conductive films 60A and 60B. In this step, the conductive films 60A and 60B were separated from each other, and the coating was also divided into a portion connected to the conductive film 60A and a portion connected to the conductive film 60B. More specifically, a coating connected to the conductive film 60A and a coating connected to the conductive film 60B are located opposite each other with a gap interposed between the conductive films 60A and 60B.

After the electron emitting device was formed in the above-mentioned method, when a characteristic of the electron emitting device was evaluated in a similar manner to that in the configuration illustrated in FIG. 2, an electron emission efficiency was higher, an electric field strength to obtain the same emission current was lower, and a variation in an electron emission characteristic for oxygen existing in an atmosphere was less than those when step 7 and step 8 were not performed. When a portion corresponding to the coating in the formed electron emitting device was measured using EELS, the existence of MoO₂, MoO₃, and La₂O₃ was confirmed, like in the electron emitting device in the example 1.

An image display apparatus using a large number of electron emitting devices is superior in formability of an electron beam, and can maintain, even if discharge is generated, a good image over a long period of time without producing a pixel defect. An image display apparatus having low power consumption caused by an improvement in electron emission efficiency can be provided.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-133289 filed Jun. 10, 2010, which is hereby incorporated by reference herein in its entirety.

What is claimed is:

1. A field emission type electron emitting device, comprising:
a cathode including a mixture of a lanthanum oxide and a molybdenum oxide.

2. The field emission type electron emitting device according to claim 1, wherein the cathode includes a conductive base, and a coating configured to cover at least a part of the base, and
wherein the coating includes a mixture of a lanthanum oxide and a molybdenum oxide.

3. The field emission type electron emitting device according to claim 1, wherein the molybdenum oxide includes MoO₂ and MoO₃.

4. The field emission type electron emitting device according to claim 1, wherein the lanthanum oxide is La₂O₃.

5. The field emission type electron emitting device according to claim 1, wherein a work function of the cathode is 3.5 eV or less.

6. The field emission type electron emitting device according to claim 1, further comprising a cathode electrode, and a gate electrode,
wherein the cathode electrode includes the cathode.

7. An image display apparatus comprising the field emission type electron emitting device according to claim 1, and a light emitter configured to emit light when irradiated with an electron emitted from the field emission type electron emitting device.

8. A radiation generation apparatus comprising the field emission type electron emitting device according to claim 1, and a target including a radiation exit surface configured to generate a radiant ray by incidence of an electron emitted from the field emission type electron emitting device.

9. A radiation imaging system comprising the radiation generation apparatus according to claim 8, and a radiation imaging apparatus configured to image a radiant ray that has been generated from the radiation generation apparatus and has been transmitted by an object to be detected.
